(19) United States
(12) Patent Application Publication
(10) Pub. No.: US 2010/0132005 A1
(43) Pub. Date: May 27, 2010

(54) Recapping media content

(75) Inventors: Windy Chien, San Francisco, CA (US); Gary Stewart, Santa Monica, CA (US); Robert Kondrk, Los Angeles, CA (US)

Correspondence Address: Morgan Lewis & Bockius LLP/ AI, 2 Palo Alto Square, 3000 El Camino Real, Suite 700, Palo Alto, CA, 94306, US

(73) Assignee: Apple Inc.

(21) Appl. No.: 12/292,733

(22) Filed: Nov. 25, 2008

(51) Int. Cl. H04N 7/173

(52) U.S. Cl. 725/133

(57) ABSTRACT

A system in accordance with the present invention may include one or more processors, memory that receives instructions from the one or more processors according to a clock operating at a frequency, one or more programs stored in the memory, with instructions to: open a media file or receive a media broadcast that may be stored locally or remotely; play the content of the media file or media broadcast at a default speed; and control the play of the content with control features such as a feature for recapping earlier media content.

### FIELD OF INVENTION

The present invention relates generally to the field of media and, in particular, to playing, viewing, and controlling video or other media.

### BACKGROUND OF INVENTION

Current media players may be used for playing live or pre-recorded content, which may be played by streaming the content over the Internet to a media player, or loading the content (e.g., source media file) from a local media storage device to a media player. Content may be comprised of audio, video, slideshow pictures, or any combinations thereof. Content may be represented according to one of many media file types (e.g., MP3, M3U, MPEG(-1, -2, -4), QuickTime Movie, AU, MIDI, JPEG, GIF, TIFF). Media players today also may offer features for controlling content, even during play. For example, media players today may offer features for playing content at a normal or accelerated speed, reverse playing content at a normal or accelerated speed, pausing the play of content, forwarding or reversing paused content, and skipping-over active content to new content. However, current media players do not provide a feature for recapping earlier media content according to a recapping control variable, then displaying descriptive information related to the recapped media content. Moreover, current media players also do not provide a feature where the descriptive information related to the recapped media content may be text, images, audio, or a combination thereof.

### SUMMARY OF THE INVENTION

Accordingly, the present invention is directed to a system and method for playing and controlling content that substantially obviates one or more problems due to limitations and disadvantages of the related art.

An object of the present invention is to provide a computer-implemented method for opening a media file or receiving a media broadcast, wherein the media file or media broadcast are stored locally or remotely; playing content of the media file or media broadcast at a default speed; and controlling the playing with control features, wherein the control features include at least a feature for recapping earlier media content.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system comprises one or more processors; memory; one or more programs stored in memory, the one or more programs comprising instructions to: open a media file or receive a media broadcast, wherein the media file or media broadcast are stored locally or remotely; play content of the media file or media broadcast at a default speed; and control the play with control features, wherein the control features include at least a feature for recapping earlier media content.

In another aspect, a computer-readable storage medium stores one or more programs configured for execution by a computer, the one or more programs comprising instructions to: open a media file or receive a media broadcast, wherein the media file or media broadcast are stored locally or remotely; play content of the media file or media broadcast at a default speed; and control the play with control features, wherein the control features include at least a feature for recapping earlier media content.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 is a block diagram illustrating an exemplary system in accordance with the present invention;

FIG. 2 illustrates an exemplary embodiment of a media player user interface in accordance with the present invention;

FIG. 3 illustrates an exemplary embodiment of a media player user interface implementing recapping with descriptive information in accordance with the present invention;

FIG. 4 illustrates an exemplary system block diagram in accordance with the present invention; and

FIG. 5 illustrates an exemplary module block diagram in accordance with the present invention.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of standalone system or client-server compatible system containing any type of client, network, server, and database elements.

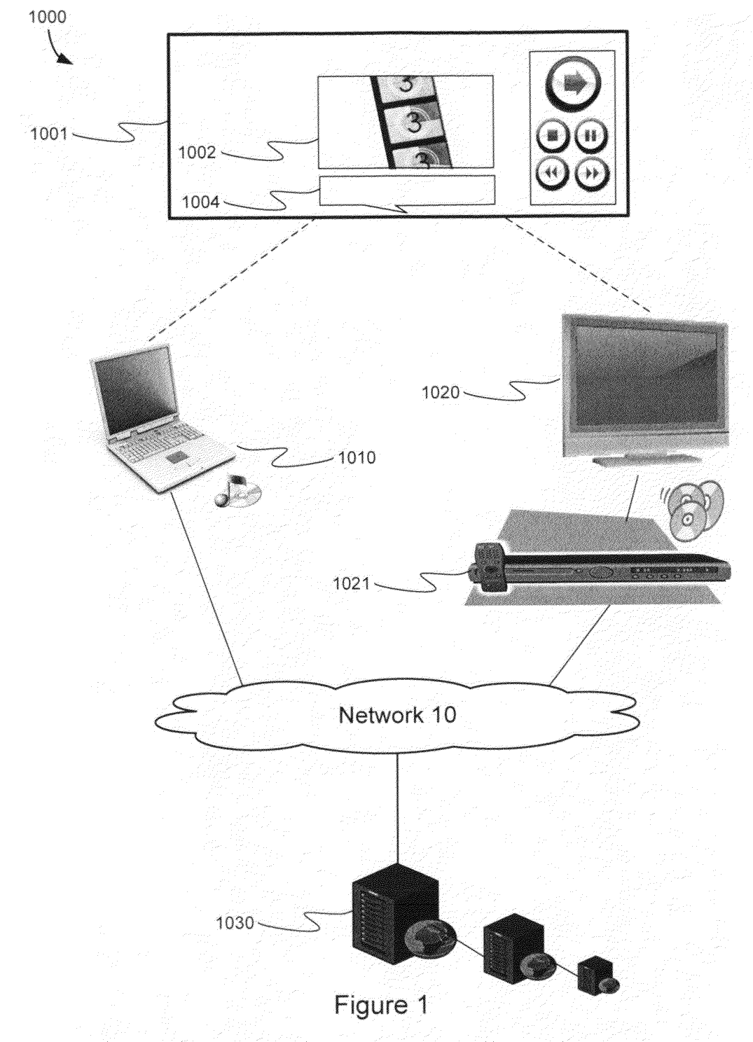

FIG. 1 is a block diagram illustrating an exemplary system 1000 in accordance with the present invention. The exemplary system 1000 comprises a computer 1010, and/or a television or other display device 1020 connected to a receiver or other media device 1021, both of which may further be connected to a network 10 (e.g., Wide Area Network (WAN), Metropolitan Area Network (MAN), or Local Area Network (LAN)) over a wired (e.g., TCP/IP over Ethernet, IEEE 802.3) or wireless (e.g., WiFi (802.11), GSM, GPRS, W-CDMA, EDGE, or the like) communications protocol/layer. The network 10 may further be connected to one or more servers 1030 with access to one or more media storage devices (e.g., storage servers, databases, or the like). The servers 1030 may receive requests over the network 10 to retrieve and transmit one or more media files/broadcasts that may contain media content (e.g., movies/videos, live/recorded television (TV) programming, pictures, music, or the like). Alternatively, the computers 1010 and/or receivers or other media devices 1021 may load media files/broadcasts locally from storage (e.g., hard drive, flash drive, CD-ROM/RW, tape drive, solid state memory, or the like), or via a connection to one or more other computers or servers (e.g., remotely). The active content 1002 window of an exemplary media player may display the content of a media file/broadcast, with corresponding descriptive information 1004 by invoking a recapping feature.

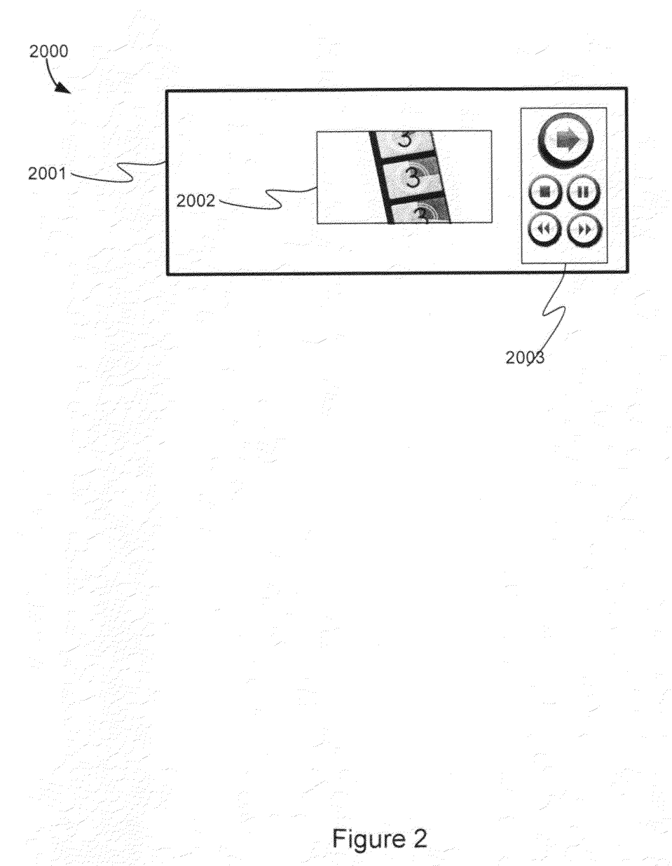

FIG. 2 illustrates an exemplary embodiment of a media player user interface in accordance with the present invention. An exemplary instance of the media player user interface 2001 comprises an active content 2002 window and a subset of media navigation features 2003. The subset of media navigation features 2003 includes a play button, a stop button, a pause button, a reverse play with acceleration button (e.g., rewind), and a forward play with acceleration button (e.g., fast forward). Not all of these elements of the exemplary instance of the media player user interface 2001 are necessarily required for its proper operation.

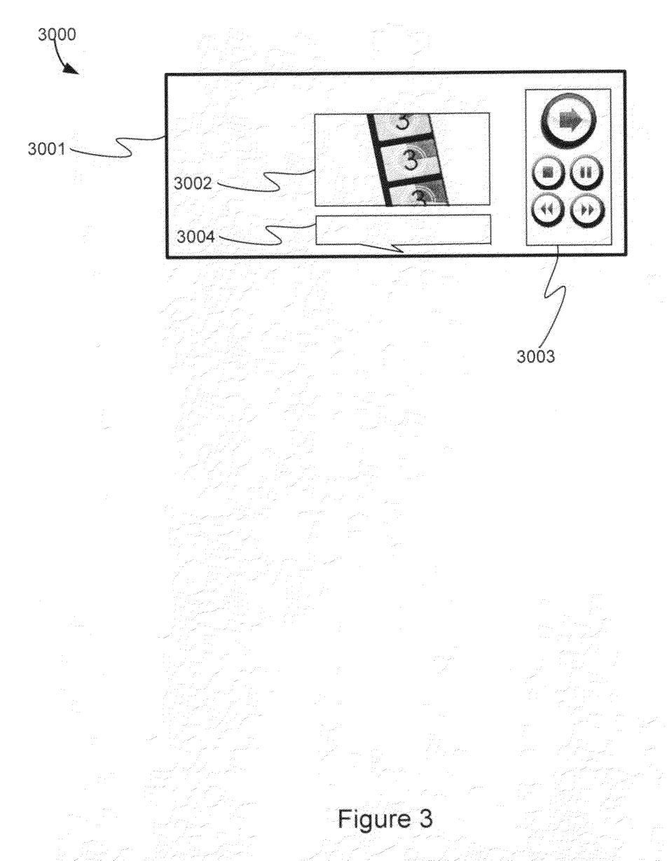

FIG. 3 illustrates an exemplary embodiment of a media player user interface implementing recapping with descriptive information in accordance with the present invention. An exemplary instance of the media player user interface 3001 comprises an active content 3002 window, a subset of media navigation features 3003, and a descriptive information component 3004. Not all of these elements of the exemplary instance of the media player user interface 3001 are necessarily required for its proper operation.

In some embodiments, FIGS. 2-3 may incorporate other media navigation features that may include a back feature, a restart scene feature, a return to threshold feature, and/or a return to critical point feature.

In some embodiments, media files/broadcasts are loaded locally from storage or remotely and may subsequently be opened by a media player 1001. The media player 1001 may be a standalone program running on the computer 1010 or the receiver or other media device 1021. Alternatively, the media player 1001 may be executed within a browser or other program and may access media files/broadcasts stored locally or remotely. The contents of a loaded media file/broadcast being played by the media player 1001 may be displayed via the screen of the computer 1010 or the TV 1020 or other display device. The media player 1001 may play the contents of the media file/broadcast in sequence order from the first frame to the last frame and the user/viewer may enjoy the current content being played 1002.

In some embodiments, the media player 1001 may play the media file/broadcast contents at a default speed (e.g., at a specific frame(s)/second(s) rate), which may depend on the type of media file/broadcast and/or the media file's/broadcast's contents. In addition, before, during, or after playing the contents of a media file/broadcast, the control functions and features of the media player 1001 may be used to accelerate the speed at which the content of an opened media file is played. The control functions and features of the media player 1001 may further be used to pause the playing of media file content, skip-over content of the media file, reverse-play content of the media file, and/or recap earlier media content.

In some embodiments, the media player 1001 may include a feature for recapping earlier media content according to a recapping control variable. The recapping control variable may be used by the feature for recapping earlier media content in order to determine which earlier media content to recap. The recapping control variable may comprise an earlier time in the media content, a threshold point in the media content, an earlier/specific scene in the media content, and/or a critical point in the media content (e.g., narration, theme, climax, ending). The exemplary media player 1001 also presents the played content 1002 and descriptive text (or other information) for the recapped content 1004 being played.

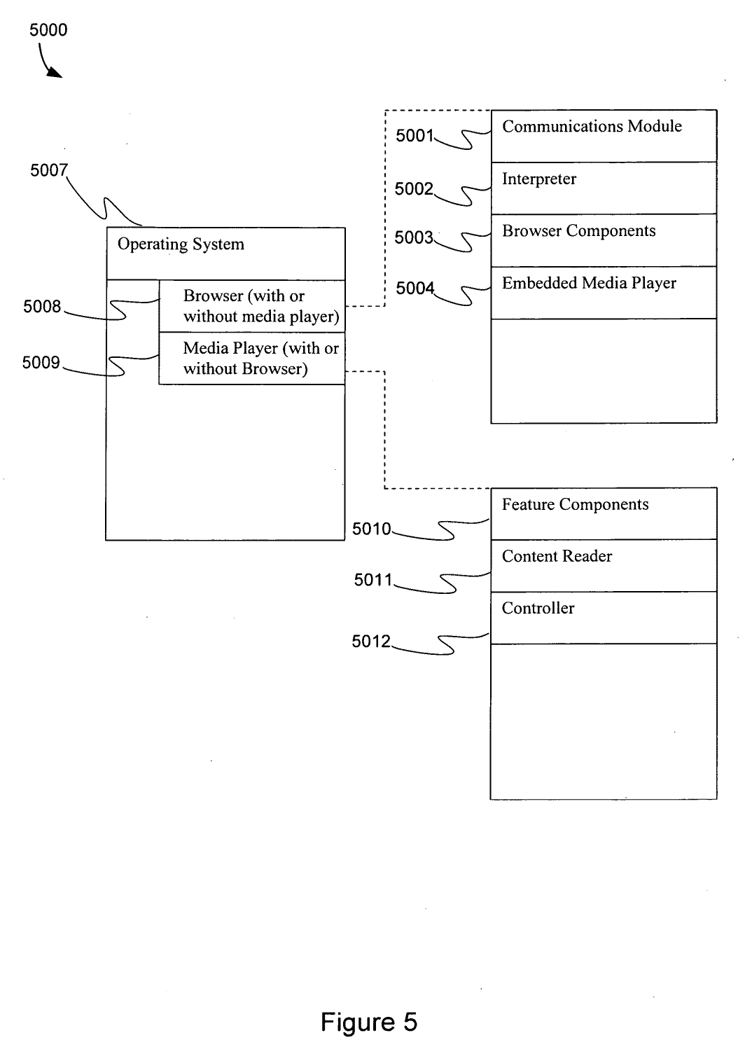

In some embodiments, the media player 2001 may set a value of a recapping control variable responsible for recapping earlier content of an opened media file. The value of the variable may be enforced by a module (e.g., FIG. 5; 5009) associated with the instance of the media player 2001. The value may, for example, be set to recap earlier media content according to an earlier time of the media content, a threshold point in the media content, an earlier/specific scene in the media content, and/or a critical point in the media content (e.g., narration, theme, climax, ending). The value may be set by the initial instance of the media player 2001, and/or the viewer/user. The value of the variable may be read by the module associated with the recapping earlier media content feature and media content may be recapped accordingly, upon activating/invoking a media navigation feature (e.g., the reverse play with acceleration button of the subset of media navigation features 2003, or a back button).

In some embodiments, the value of the variable may be manipulated through the media player 2001 and changed from its original or current value. For example, the variable may be manipulated for recapping earlier media content according to time (e.g., ten seconds, one minute, 5 minutes, 20 minutes, 1 hour, or any other applicable time interval), or according to an earlier/specific scene, or according to any specification known to those skilled in the art. Alternatively, the value may be manipulated for recapping earlier media content according to a critical point, or according to a threshold point, or according t any specified point known to those skilled in the art.

In some embodiments, the recapping of earlier media content feature includes displaying descriptive information related to the recapped media content 3004. For example, by activating/invoking a media navigation feature such as the back button or the reverse play with acceleration button of the subset of media navigation features 3003, closed-captioning text, other descriptive text, an image, audio, or a combination of any of the foregoing may be displayed in the descriptive information 3004 component. Descriptive information may also be displayed via a pop-up window or other graphical user interface component (GUI) without departing from the scope of the present invention. The media player 3001 module (e.g., FIG. 5; 5009) for implementing the recapping of earlier media content feature may retrieve the corresponding descriptive information from a text file containing the respective information, along with timestamp, threshold, scene, critical point, or other hook for linking the point to which the media content is being recapped with the respective descriptive information. In the case of a media file/broadcast, where closed captioning may be available, the descriptive information may comprise closed captioning corresponding to the point to which the media content is being recapped. The closed captioning may be displayed via the active content window 3002 or the descriptive information 3004 component.

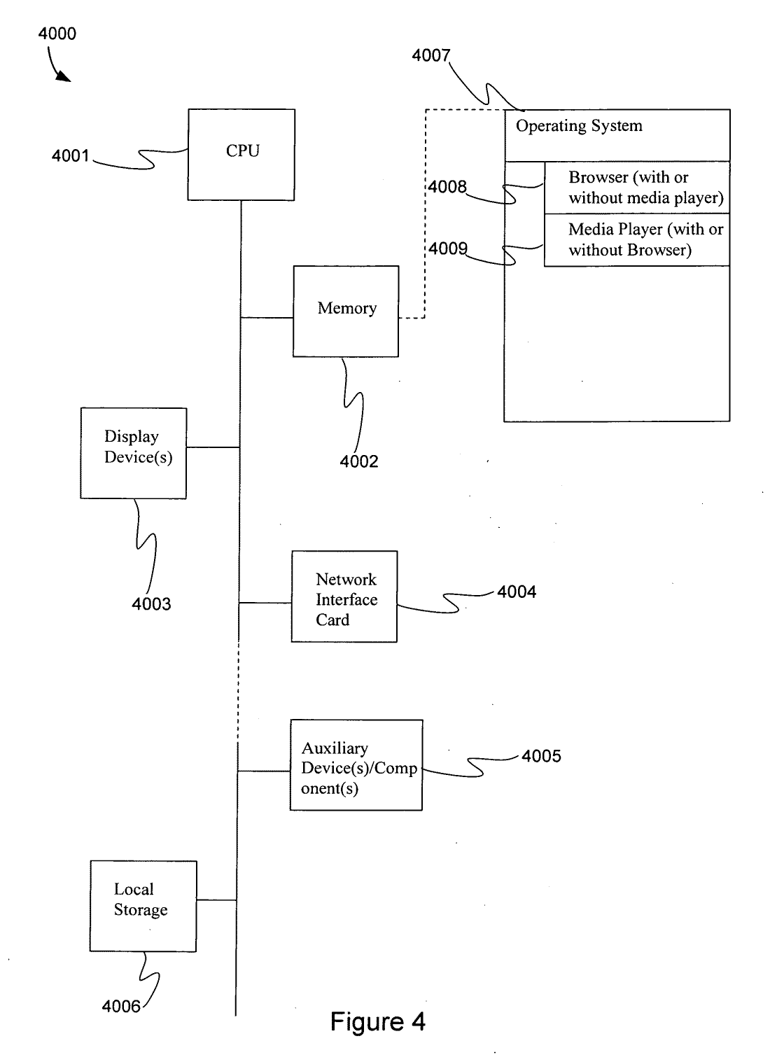

FIG. 4 illustrates an exemplary system block diagram in accordance with the present invention. The exemplary system 4000 for implementing an exemplary embodiment of the present invention comprises a computer processing unit (CPU) 4001, memory 4002, display device(s) 4003, a network interface card (NIC) 4004, auxiliary device(s)/component(s) 4005, and local storage 4006. These elements may communicate over one or more local buses. The CPU 4001 may fetch instructions to execute from memory 4002, where the instructions may be from an operating system 4007 and, further, from a browser 4008 (with or without having an embedded media player) and/or media player 4009 (with or without being embedded in a browser) executing via the operating system 4007. The media player 4009 may receive/fetch media files from local storage 4006 and/or over a network 10 using the NIC 4004 for communication with one or more servers 1030. The media player 4009 may also be embedded within a browser 4008 and may access media files in local storage 4006 and/or over a network 10. The display device(s) 4003 may be a laptop or computer display, TV screen, or other display capable of receiving display signals. The display signals may comprise, for example, one or more frames per second of video or other media content. The media content may be opened and played by the media player 4009. Other auxiliary device(s)/component(s) 4005 may also receive or otherwise communicate via the local bus. For example, a portable media player, mobile telephone, or other auxiliary device may act as a source/sink of media files. The auxiliary device(s)/component(s) 4005 may also be additional display devices and/or media devices capable of supporting the execution of the media player.

FIG. 5 illustrates an exemplary module block diagram in accordance with the present invention. The exemplary modules 5000 for implementing an exemplary embodiment of the present invention comprise browser modules 5001-5004 and/or media player modules 5010-5012. The browser modules 5001-5004 may comprise a communications module 5001, an interpreter 5002 (e.g., HTML or script/mark-up language interpreter), browser components 5003 (e.g., navigation functions, add-in(s)/on(s), custom user options), and an embedded media player 5004. The media player modules 5010-5012 may comprise feature components 5010, a content reader 5011, and a controller 5012. The browser modules may be used to implement the browser-related features of the exemplary embodiments, while the media player modules may be used to implement the media player-related features of the exemplary embodiments.

In some embodiments, the communications module 5001 receives and transmits data over a network (e.g., network 10) through one or more ports (e.g., HTTP port 80); the interpreter 5002 may interpret scripts/mark-up languages and execute them in accordance with their instructions; the browser components 5003 may implement features such as those for navigating the Internet, supporting add-in(s)/on(s), implementing custom user options and executing in accordance with those options (e.g., permissions, home page preference, bookmarks, script preferences, history preferences, privacy preferences, web page preferences, and/or other Internet/user options); and, the embedded media player 5004 (which may, in some embodiments, be an add-in/on) may play media content in accordance with the present invention as described herein.

In some embodiments, the feature components 5010 may implement features such as media playlist management, media type conversion, media compression/decompression, media playlist/library synchronization, media ripping/burning from/to external storage mediums, media player options (e.g., window size, volume, media quality, play speed); the content reader 5011 may read and decode the contents of a media file, where the media file contents may be represented according to a specific file type and compressed; and, the controller 5012 may implement features for opening, navigating, controlling access to, and/or manipulating media files and/or their content.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

We claim:

1. A computer-implemented method for playing content of a media file or media broadcast, comprising:
opening a media file or receiving a media broadcast, wherein the media file or media broadcast are stored locally or remotely;
playing content of the media file or media broadcast at a default speed; and
controlling the playing with control features, wherein the control features include at least a feature for recapping earlier media content.

2. The computer-implemented method of claim 1, wherein the feature for recapping earlier media content comprises a recapping control variable.

3. The computer-implemented method of claim 1, wherein the recapping control variable is at least one from the group comprising: a time, a threshold, a scene, or a critical point.

4. The computer-implemented method of claim 1, wherein the feature for recapping earlier media content is activated by invoking a media navigation feature.

5. The computer-implemented method of claim 4, wherein the media navigation feature is at least one from the group comprising: a back feature, a restart scene feature, a return to threshold feature, or a return to critical point feature.

6. The computer-implemented method of claim 1, wherein the feature for recapping earlier media content includes displaying descriptive information related to recapped media content.

7. The computer-implemented method of claim 6, wherein the descriptive information related to recapped media content is at least one from the group comprising: text, image, audio, or a combination thereof.

8. A system, comprising:
one or more processors;
memory;
one or more programs stored in memory, the one or more programs comprising instructions to:
open a media file or receive a media broadcast, wherein the media file or media broadcast are stored locally or remotely;
play content of the media file or media broadcast at a default speed; and
control the play with control features, wherein the control features include at least a feature for recapping earlier media content.

9. The system of claim 8, wherein the feature for recapping earlier media content comprises a recapping control variable.

10. The system of claim 8, wherein the recapping control variable is at least one from the group comprising: a time, a threshold, a scene, or a critical point.

11. The system of claim 8, wherein the feature for recapping earlier media content is activated by invoking a media navigation feature.

12. The system of claim 11, wherein the media navigation feature is at least one from the group comprising: a back feature, a restart scene feature, a return to threshold feature, or a return to critical point feature.

13. The system of claim 8, wherein the feature for recapping earlier media content includes displaying descriptive information related to recapped media content.

14. The system of claim 13, wherein the descriptive information related to recapped media content is at least one from the group comprising: text, image, audio, or a combination thereof.

15. A computer-readable storage medium storing one or more programs configured for execution by a computer, the one or more programs comprising instructions to:
open a media file or receive a media broadcast, wherein the media file or media broadcast are stored locally or remotely;
play content of the media file or media broadcast at a default speed; and
control the play with control features, wherein the control features include at least a feature for recapping earlier media content.

16. The computer-readable storage medium of claim 15, wherein the feature for recapping earlier media content comprises a recapping control variable.

17. The computer-readable storage medium of claim 15, wherein the recapping control variable is at least one from the group comprising: a time, a threshold, a scene, or a critical point.

18. The computer-readable storage medium of claim 15, wherein the feature for recapping earlier media content is activated by invoking a media navigation feature.

19. The computer-readable storage medium of claim 18, wherein the media navigation feature is at least one from the group comprising: a back feature, a restart scene feature, a return to threshold feature, or a return to critical point feature.

20. The computer-readable storage medium of claim 15, wherein the feature for recapping earlier media content includes displaying descriptive information related to recapped media content.

21. The computer-readable storage medium of claim 20, wherein the descriptive information related to recapped media content is at least one from the group comprising: text, image, audio, or a combination thereof.
